(19) United States
(12) Patent Application Publication
(10) Pub. No.: US 2008/0144099 A1
(43) Pub. Date: Jun. 19, 2008

(54) Image forming restriction control system, image forming restriction control method, and recording medium storing computer program for controlling restriction of image forming

(76) Inventor: Kenji Hagiwara, Kanagawa (JP)

Correspondence Address: IPUSA, P.L.L.C, 1054 31ST STREET, N.W., Suite 400, Washington, DC, 20036, US

(21) Appl. No.: 12/000,219

(22) Filed: Dec. 11, 2007

(30) Foreign Application Priority Data
Dec. 18, 2006 (JP) 2006-339324

(51) Int. Cl. G06F 15/00

(52) U.S. Cl. 358/1.15

(57) ABSTRACT

An image forming restriction control system includes an image forming apparatus; and a use restriction device configured to restrict use of the image forming apparatus; wherein the image forming apparatus and the use restriction device are connected to a network, and the use restriction device includes a user information storage part, an image forming number obtaining part, a use information storage part, a notification part, a comparing part, and a control part.

### BACKGROUND OF THE INVENTION

1. Field of the Invention

The present invention generally relates to image forming restriction control systems, image forming restriction control methods, and recording media storing computer programs for controlling the restriction of image forming.

More specifically, the present invention is related to an image forming restriction control system whereby use of each image forming apparatus connected to network is properly restricted, an image forming restriction control method, and a recording medium storing a computer program for controlling the restriction of image forming.

2. Description of the Related Art

Conventionally, in image forming apparatuses such as facsimile machines, copiers, multi-function apparatuses and printers, the number of pages where images are formed has been limited for every image forming apparatus for the purpose of conserving paper resources.

However, in recent years, in normal offices or the like, reduction of TCO (Total Cost of Ownership) has been regarded as important. Because of this, proper restriction cannot be achieved by only making an upper limit restriction on the use of paper for every image forming apparatus as means for reducing the amount of paper used or the printing amount.

The assignee of the present invention has suggested a print management system (see Japanese Laid-Open Patent Application Publication No. 2005-100111). In this print management system, a client apparatus, a printing apparatus and a server apparatus are connected to a network. The server apparatus causes the printing apparatus to perform a printing process based on instructions from the client apparatus. The server apparatus relates user information for every user and printing number limitation information with respect to the user to each other and stores the information. When receiving a printing job, the server apparatus specifies a user of a client apparatus which is the source of the printing job and limits the number of pages for printing based on the printing number limitation information with respect to the user.

However, in the above-mentioned related art, if the number of printed pages exceeds the printing limitation number, printing from next time will be restricted. Because of this, the user does not find out that the use of the printing apparatus is restricted by the image forming restriction control system until trying to use the printing apparatus the next time for printing.

Accordingly, even in a situation requiring urgent printing, the user finds that printing cannot be performed when the user attempts to print. Therefore, improvement in the convenience of use is required.

In addition, the reasons why the printing apparatus cannot be used may be based on not only the printing restriction but also malfunction of the printing apparatus or the like. Accordingly, the user cannot properly learn the reason why the printing device cannot be used, restriction by the image forming restriction control system or malfunction.

### SUMMARY OF THE INVENTION

Accordingly, embodiments of the present invention may provide a novel and useful image forming restriction control system, image forming restriction control method, and recording medium storing a computer program for controlling the restriction of image forming, solving one or more of the problems discussed above.

More specifically, the embodiments of the present invention may provide an image forming restriction control system whereby the reason for restriction of use of an image forming apparatus can be learned in a proper manner by a user so that convenience of use can be improved; an image forming restriction control method; and a recording medium storing a computer program for controlling the restriction of image forming.

One aspect of the present invention may be to provide an image forming restriction control system, including:

an image forming apparatus; and

a use restriction device configured to restrict use of the image forming apparatus;

wherein the image forming apparatus and the use restriction device are connected to a network, and

wherein the use restriction device includes
a user information storage part configured to store user information with respect to a user who is permitted to use the image forming apparatus;
an image forming number obtaining part configured to obtain a total sum of the number of pages where an image is formed for a designated time in each of plural of the image forming apparatuses for each of plural of the users who are permitted to use the image forming apparatuses;
a use information storage part configured to store the total sum of the number of the pages where the image is formed for every one of the users obtained by the image forming number obtaining part and a preset use restriction number;
a notification part configured to report information to the user;
a comparing part configured to compare the total sum of the number of pages where an image is formed and the preset use restriction number, at the designated timing; and
a control part configured to restrict the use of the image forming apparatuses by one of the users and initiate a notifying process for notifying the one of the users of the restriction of use to be performed by the notification part, in a case where the total sum of the number of the pages where the image is formed exceeds the preset use restriction number.

Another aspect of the present invention may be to provide an image forming restriction control method wherein an image forming apparatus and a use restriction device configured to restrict use of the image forming apparatus are connected to a network, and restriction of image forming by the image forming apparatus is controlled by the use restriction device, the method including:

an image forming number obtaining process step of obtaining the total sum of the number of pages where an image is formed for a designated time in each of plural of the image forming apparatuses for each of plural of the users who are permitted to use the image forming apparatuses;

a comparing process step of comparing the total sum of the number of images formed and the preset use restriction number, at the designated timing; and

a control process step of restricting the use of the image forming apparatuses by one of the users and causing a notifying process for notifying the restriction of use to the restricted one of the users, in a case where the total sum of the number of pages where the image is formed exceeds the preset use restriction number.

Another aspect of the present invention may be to provide a recording medium storing a computer program for controlling restriction of image forming in an image forming apparatus by a use restriction device where the image forming apparatus and the use restriction device configured to restrict use of the image forming apparatus are connected to a network, the computer program implementing a method, the method including:

an image forming number obtaining process step of obtaining the total sum of the number of pages where an image is formed for a designated time in each of plural of the image forming apparatuses for each of plural of the users who are permitted to use the image forming apparatuses;

a comparing process step of comparing the total sum of the number of images formed and the preset use restriction number, at the designated timing; and

a control process step of restricting the use of the image forming apparatuses by one of the users and causing a notifying process for notifying the restriction of use to the restricted one of the users, in a case where the total sum of the number of pages where the image is formed exceeds the preset use restriction number.

According to the embodiments of the present invention, the use restriction device configured to restrict the use of the image forming apparatus connected to the network is provided. The use restriction device obtains the total sum of the number of pages where images are formed for a designated time in each image forming apparatus for every user. The use restriction device compares the total sum of the number of pages where images are formed and the preset use restriction number, at the designated timing. In the case where the total sum of the number of pages where images are formed exceeds the preset use restriction number, the use restriction device restricts the use of the image forming apparatus by the user and reports the restriction of use to the user by the designated notifying method.

Accordingly, the user can learn in a proper manner that the use of the image forming apparatus is restricted, so that the use restriction is properly performed and the convenience of use can be improved.

Other objects, features, and advantages of the present invention will become more apparent from the following detailed description when read in conjunction with the accompanying drawings.

### BRIEF DESCRIPTION OF THE DRAWINGS

FIG. 1 is a system structural diagram of a printing system where an embodiment of an image forming restriction control system, an image forming restriction method, and a recording medium are applied;

FIG. 2 is a block diagram of a network device, a use restriction server, and a client terminal;

FIG. 3 is a counter value table of the network device shown in FIG. 2;

FIG. 4 is an example of a device information table of a device information storing part of the use restriction server shown in FIG. 2;

FIG. 5 is an example of a counter information table of a counter information storing part of the use restriction server shown in FIG. 2;

FIG. 6 is an example of a user information table of a user information storing part of the use restriction server shown in FIG. 2;

FIG. 7 is a timing chart showing a process flow of a counter value collection and inspection process of the printing system shown in FIG. 1;

FIG. 8 is a timing chart showing a process flow following the process shown in FIG. 7 in a case where a notification e-mail is sent as a result of the counter value collection and inspection process shown in FIG. 7;

FIG. 9 is a timing chart showing a process flow following the process shown in FIG. 7 in a case where a Web-screen notification is sent as a result of the counter value collection and inspection process shown in FIG. 7; and

FIG. 10 is an example of notification contents of a using state notification process for a designated time by the printing system shown in FIG. 1.

### DETAILED DESCRIPTION OF THE PREFERRED EMBODIMENTS

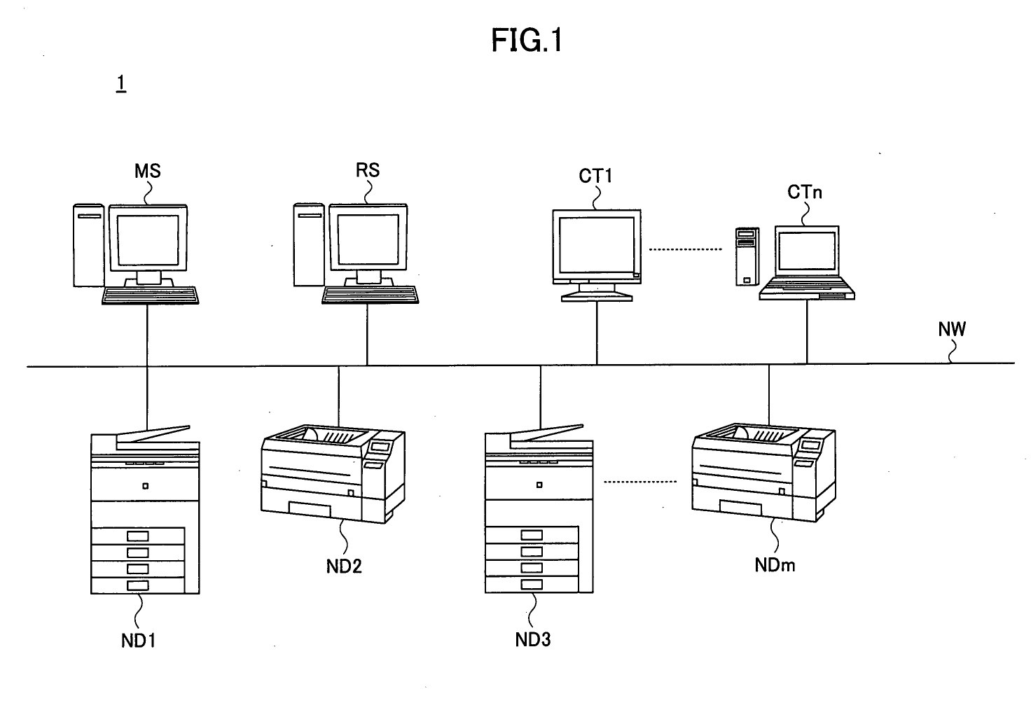

A description is given below, with reference to the FIG. 1 through FIG. 10 of embodiments of the present invention.

### First embodiment of the present invention

FIG. 1 is a system structural diagram of a printing system 1 where an embodiment of an image forming restriction control system, an image forming restriction method, and a recording medium are applied.

As shown in FIG. 1, in the printing system 1, plural client terminals CT1 through CTn, plural network devices ND1 through NDm, a use restriction server RS, and a mail server MS are connected to a network NW such as a LAN (Local Area Network).

In this embodiment, printing jobs from the client terminals CT1 through CTn are directly sent to the network devices ND1 through NDm via the network NW. Each of the network devices ND1 through NDm, based on use possible/impossible information from the use restriction server RS, performs use restriction control of itself for every user.

Normal personal computers or the like are used as the client terminals CT1 through CTn. If the user requests the printing of documents or the like by using one of the client terminals CT1 through CTn, the document printing job is sent to the designated network device ND1 through NDm via the network NW.

In addition, in the printing system 1, when the user uses one of the client terminals CT1 through CTn in order to send the printing job to the designated network device ND1 through NDm, in order to specify the user using the network devices ND1 through NDm, identification information (a combination of the user name and password or user ID for identifying the user) of the user is added to the printing job and sent.

Printers, MFPs (Multi-Function Processing machines), or the like are used as the network devices (image forming apparatuses) ND1 through NDm as shown in FIG. 1. The network devices ND1 through NDm have control parts, paper feeding parts, printing parts (image forming parts), paper discharge parts, operations display parts, and other parts necessary for implementing printing processes and performing the printing processes corresponding to the printing jobs from the client terminals CT1 through CTn.

A computer is used as the use restriction server RS and the use restriction server RS has a hardware structure which is typical for a server. As discussed below, the use restriction server RS performs information management for restricting use of the network devices ND1 through NDm by the user of each client terminal CT1 through CTn.

The mail server MS provides the service of collection and sending e-mails to the users using the client terminals CT1 through CTn connected to the network NW. In particular, the mail server MS sends e-mails where use restriction related information is provided from the use restriction server RS to the users of the designated client terminals CT1 through CTn.

In addition, in the printing system 1, the use restriction server RS, acting as a use restriction device, and the network devices ND1 through NDm, acting as image forming devices, read an image forming restriction control program recorded in a recording medium such as a flexible disk, a CD (Compact Disk), a DVD (Digital Video Disk), or a memory card. Thus, the use restriction server RS and the network devices ND1 through NDm function as an image forming control restriction system for implementing an image forming restriction control process discussed below.

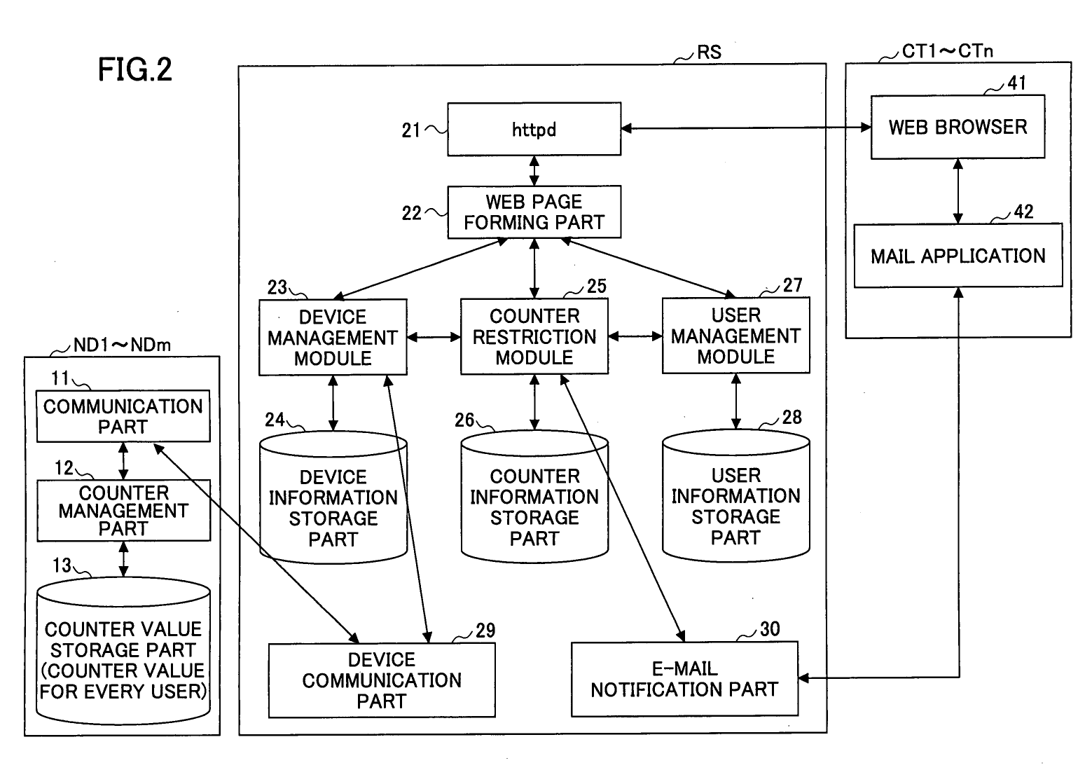

In the printing system 1, in order to properly implement use restriction of the network devices ND1 through NDm by the users of each client terminal CT1 through CTn, the client terminals CT1 through CTn, the network devices ND1 through NDm and the use restriction server RS have functions necessary for use restriction as shown in FIG. 2, in addition to the above-discussed structures.

In other words, as shown in FIG. 2, each network device ND1 through NDm has a communication part 11, a counter management part 12, a counter value storage part 13, and other parts. Here, FIG. 2 is a block diagram of the network device, the use restriction server, and the client terminal.

The communication part 11 performs communications with the client terminals CT1 through CTn or the use restriction server RS via the network NW. The communication part 11 exchanges various kinds of information with the client terminals CT1 through CTn, such as sending printing jobs or sending and receiving identification information. The communication part 11 also receives the counter request, sends the counter value, and performs other tasks with the use restriction server RS.

When a printing job is performed, the counter management part 12 counts the number of printed pages for every user, every application, and every printing setting (full color, two-color, single color, black and white, copier and printer, and the like) so as to cause the counter value storage part 13 to store the number of printed pages as the counter value. In addition, when the communication part 11 receives a counter request from the use restriction server RS, the counter management part 12 takes out the counter value for every user from the counter value storage part 13 so that the counter values are sent to the use restriction server RS via the communication part 11.

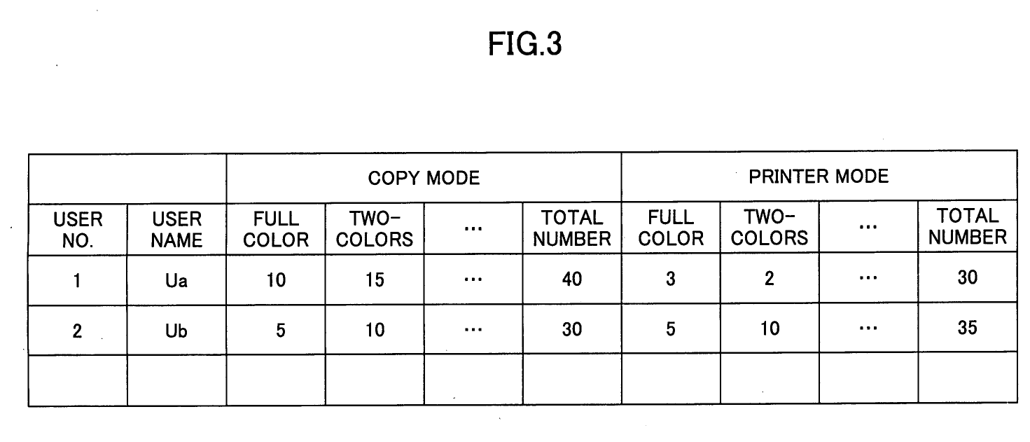

A non-volatile memory such as a hard disk drive is used as the counter value storage part 13. The counter value storage part 13 stores the number of printed images counted, based on the printing settings for every user and every application such as the copier and the printer in a counter value table shown in FIG. 3, for example. The counter value storage part 13 also stores user information such as the user name and the password for every user in a table format or the like.

FIG. 3 is a counter value table of the network device shown in FIG. 2. The counter value storage part 13 stores the counter values in the table format or the like as shown in FIG. 3, for example.

The counter value storage part 13 stores the user name and the copy total counter value (copy total number) for every user. The counter value storage part 13 stores the counter value (for example, copy full color counter value, copy two-color color counter value, copy single color counter value, and copy black and white counter value) and a printer total counter value for every individual copy printing setting. The counter value storage part 13 stores the counter value (for example, printer full color counter value, printer two-color color counter value, printer single color counter value, and printer black and white counter value) for every individual printer printing setting.

Referring back to FIG. 2, the use restriction server RS includes an httpd 21, a Web page forming part 22, a device management module 23, a device information storage part 24, a counter restriction module 25, a counter information storage part 26, a user management part 27, a user information storage part 28, a device communication part 29, an e-mail notification part 30, and other parts.

The httpd 21 receives a request from a browser by a Daemon program on the Web server. The Web page forming part 22 generates a Web page for displaying in the browser based on the request from the httpd 21.

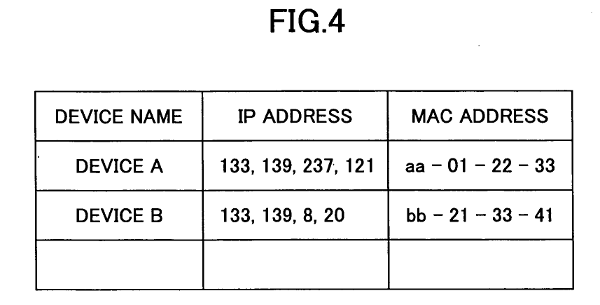

A non-volatile memory such as a hard disk drive or a RAM (Random Access Memory) using a battery backup is used as the device information storage part 24. The device information storage part 24 stores, for example, as shown in FIG. 4, device names of the network devices ND1 through NDm which are subjects of use restriction by the use restriction server RS, IP addresses, MAC (Media Access Control) addresses, and others in a table format or the like. Here, FIG. 4 is a device information table of the device information storing part 26 of the use restriction server RS shown in FIG. 2.

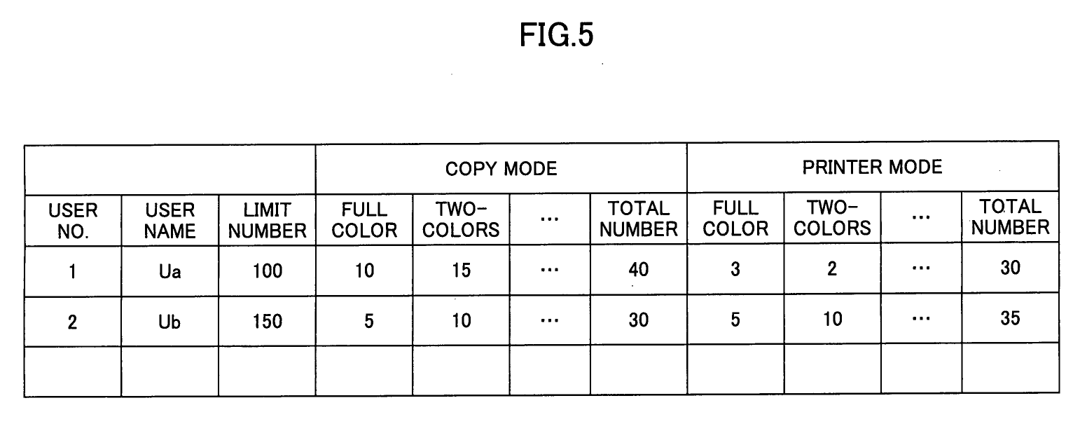

A non-volatile memory such as a hard disk drive or a RAM (Random Access Memory) with a battery backup is used as the counter information storage part 26. The counter information storage part (use information storage part) 26 stores the number for printed pages counted based on a print setting for every user and every application such as a copier or a printer. The number is stored as a counter value table shown in FIG. 5. Here, FIG. 5 is a counter information table of the counter information storing part 26 of the use restriction server RS shown in FIG. 2.

In other words, as shown in FIG. 5 for example, the counter information storage part 26 stores, as the counter value, the user name, the limit value (limitation number), the copy total counter value (copy total number), the counter value for every individual copier print setting (for example, the copy full color counter value, copy two-colors counter value, copy single color counter value, copy black and white counter value, and the like), the printed pages total counter value (print total number), and the counter value for every individual printer print setting (for example, the printer full color counter value, printer two-color counter value, printer single color counter value, printer black and white counter value, and the like), in the table format or the like.

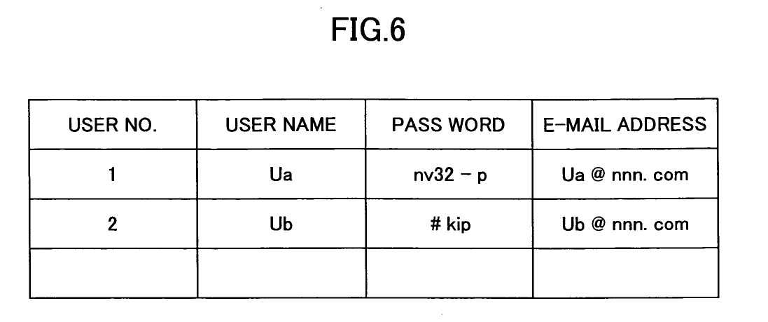

A non-volatile memory such as a hard disk drive or a RAM (Random Access Memory) with a battery backup is used as the user information storage part 28. The user information storage part 28 stores, for example, as shown in FIG. 6, the user names, passwords, e-mail addresses, and others in a table format. Here, FIG. 6 is a user information table of the user information storing part 28 of the use restriction server RS shown in FIG. 2.

The device management module 23 manages the device information of the network devices ND1 through NDm stored in the device information storage part 24.

The counter restriction module (comparing part and control part) 25 performs management such as registration, reading, change, and deletion of the counter value for every user of the counter information storage part 26. The counter restriction module (comparing part, control part) 25 orders an e-mail notification or a pop-up display when printing exceeds the counter check or limit for every user.

The user management part 27 performs management such as registration, reading, change, and deletion of the user information in the user information storage part 28.

The device communication part 29 communicates with the network devices ND1 through NDm via the network NW so as to obtain the counter values for every user from the network devices ND1 through NDm. The device management module 23 and the device communication part 29 function as an image forming number obtaining part as a whole.

The e-mail notification part 30 makes e-mail notification under the control by the counter restriction module 25. That is, the e-mail notification part 30 sends an e-mail to the user whose printing amount exceeds the limit value (limit number) via the network NW.

The client terminals CT1 thorough CTn have the structure of a normal personal computer and also include a Web browser 41, an e-mail application 42, and others.

The Web browser 41 accesses the use restriction server RS so as to access the home page provided by the use restriction server RS. Via the Web browser 41, the counter value information of the network devices ND1 through NDm for the users of the client terminals CT1 through CTm and the use restriction information are confirmed. Due to the confirmation of the counter values and other values, use restriction is applied against the user who is confirmed to have exceeded a limitation. When the pop-up display order is sent from the use restriction server RS, a pop-up is displayed.

The e-mail application 42 performs e-mail communication via the network NW. In particular, the e-mail application 42 receives e-mail such as a use restriction notification from the use restriction server RS so as to display the e-mail notification.

Next, operations of embodiments of the present invention are discussed.

In the printing system 1 of the embodiment of the present invention, the number of printed pages is counted for every user. If the number of printed pages reaches the limitation number, use of the network devices ND1 through NDm by the user is limited and notification is sent to the user.

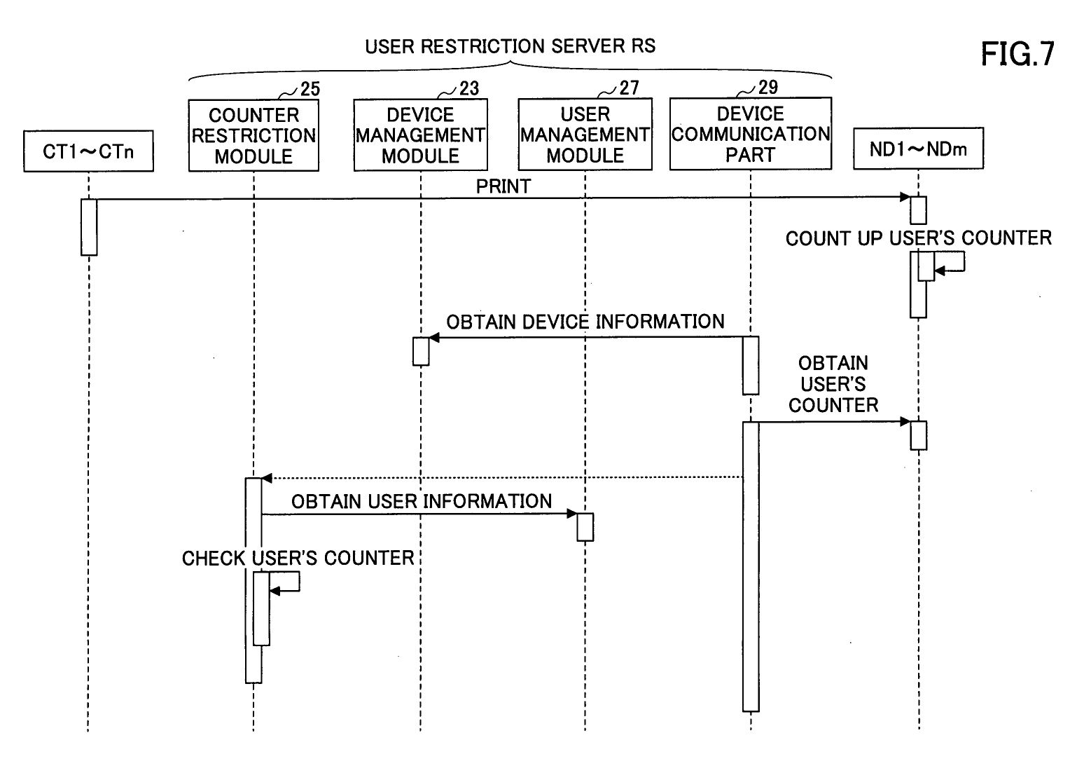

FIG. 7 is a timing chart showing a process flow of a counter value collection and inspection process of the printing system 1 shown in FIG. 1.

As shown in FIG. 7, when the user information and the printing jobs are sent from the client terminals CT1 through CTn to the network devices ND1 through NDm via the network NW and the network devices ND1 through NDm perform the printing processes, each of the network devices ND1 through NDm counts the number of printed pages (printer number) by using the counter management part 12. As shown in FIG. 3, the network devices ND1 through NDm add the printed number of pages to the counter value in the print setting information of the printing job in the printer mode of each of the users so as to make the counter value storage part 13 store them.

The network devices ND1 through NDm perform the count process of the counter value and the storage process for the counter value storage part 13 every time the printer process is performed. In addition, when the user inputs the user information of the ID card or the like and performs the copying process based on the copy request from the operations display part, the network devices ND1 through NDm, at every time of copying, count the printed number in the printing setting of the copier in the copy mode designated by the user. The network devices ND1 through NDm add the printed number of pages to the counter value in the print setting information in the printer mode of the user so as to make the counter value storage part 13 store them.

Next, in the use restriction server RS, at the collection timing of the designated counter values (periodic time intervals, designated setting timing, or the like), the device communication part 29 requests the device management module 23 to obtain the device information. The device management module 23 obtains the device information of the network devices ND1 through NDm, which are subjects of the management, stored in the device information storage part 24 and delivers the information to the device communication part 29.

The device communication part 29, based on the device information received from the device management module 23, requests to obtain the counter values from the network devices ND1 through NDm which are management subjects, via the network NW.

When the communication part 11 receives the request for obtaining the counter values from the use restriction server RS, the counter management part 12 obtains the counter value information of all users stored in the counter storage part 13 so that the counter value information is sent to the use restriction server RS via the communication part 11 and the network NW.

When the use restriction server RS receives the counter value information from each network device ND1 through NDm via the device communication part 29, the counter restriction module 25 obtains the user information from the user management module 27, collects the counter values from each network device ND1 through NDm for every user and every printing setting of the application mode, and calculates the total sum of the counter values. The calculated total sum of the counter values is stored in the counter information storage part 26 as shown in FIG. 5.

When the counter restriction module 25 completes the calculation of the total sum of the counter values sent from each network device ND1 through NDm with respect to all users and storage of the values and sums in the counter information storage part 26, the counter restriction module 25 compares, for every user, a limit value (the use restriction number) set for the user and registered in the counter information storage part 26 and the total sum of the counter values of the user, so as to determine whether the sum of the counter values of the user exceeds the limit value.

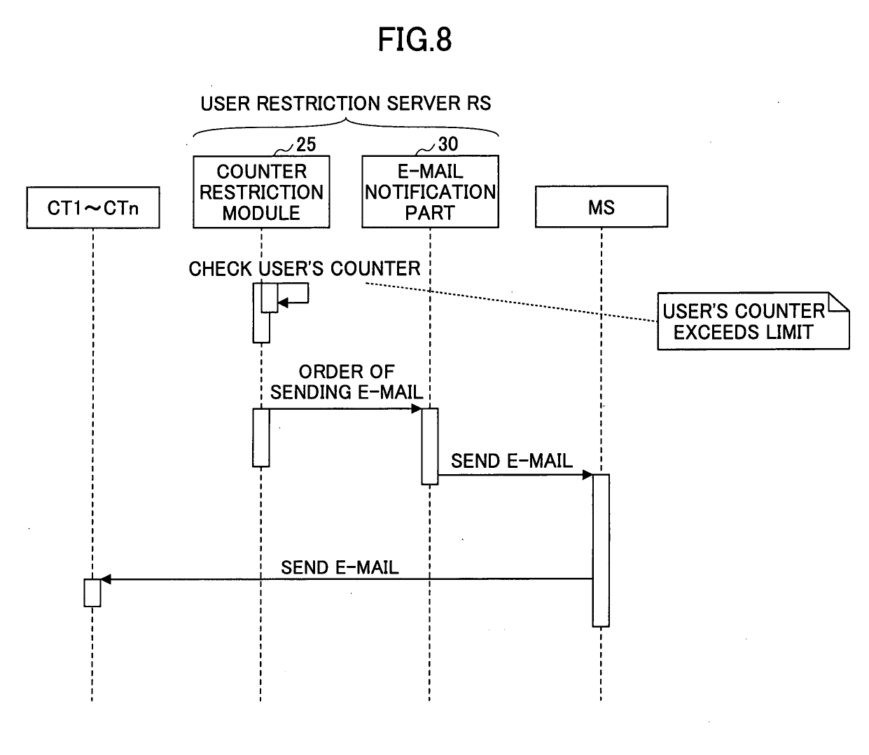

As shown in FIG. 8, the counter restriction module 25 determines whether the counter values sum exceeds the limit value for every user. Here, FIG. 8 is a timing chart showing a process flow following the process shown in FIG. 7 in a case where a notification e-mail is sent as a result of the counter value collection and inspection process shown in FIG. 7.

If the counter values sum exceeds the limit value, the counter restriction module 25 specifies the user and orders sending an e-mail indicating that the counter values sum exceeds the limit value to the e-mail notification part 30. The e-mail notification part 30 sends, via the mail server MS, an e-mail indicating that the counter values sum exceeds the limit value to the client terminal CT1 through CTn of the user who is the subject of the e-mail sending order.

This e-mail notifies the user that the counter values sum exceeds the limit value such as “The counter values sum reached the use upper limit of the network device (MFP, printer, or the like). You will not be able to use the network devices.”

Thus, according to the printing system 1 of the embodiments of the present invention, the use restriction server RS which is configured to restrict use of the network devices ND1 through NDm connected to the network NW obtains the total sum of the number of pages where the image is formed for a designated time in each network device ND1 through NDm for every user.

The use restriction server RS compares the total sum of the number of pages where the image is formed and the preset use restriction number, at the designated timing.

In the case where the total sum of the number of pages where the image is formed exceeds the limit value, the use restriction server RS restricts the use of the network devices ND1 through NDm by the user and notifies the user of the restriction of use by a notifying method such as an e-mail.

Accordingly, the user can learn in an appropriate manner that the use of the network device ND1 through NDm is restricted, so that the use restriction is properly performed and the convenience of use can be improved.

In addition, in the printing system 1 of the embodiments of the present invention, an e-mail indicating that the counter values sum exceeds the limit value is sent from the use restriction server RS to the user so that the user is notified that the use restriction is in effect.

Accordingly, restriction of use of the network devices ND1 through NDm can be properly and securely learned by the user so that the convenience of use can be further improved.

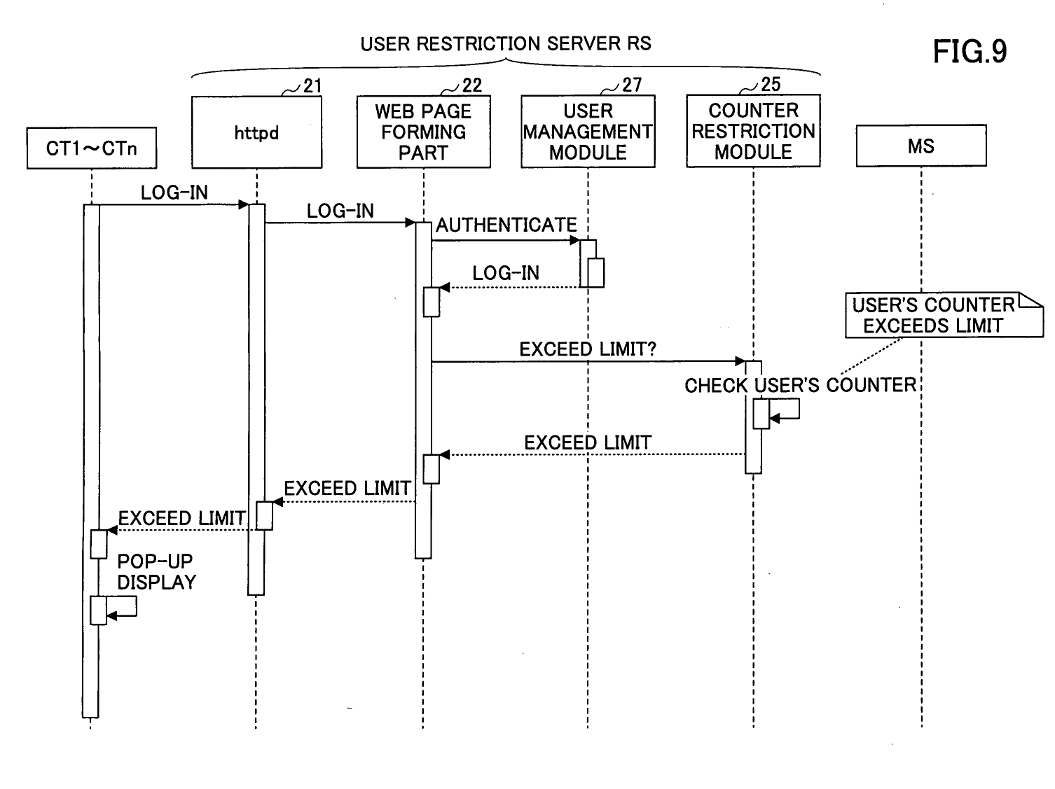

While the notification is made by e-mail in the above-discussed example, the way of notification is not limited to e-mail. A browser screen of the Web may be used for the notification, as shown in FIG. 9.

Here, FIG. 9 is a timing chart showing a process flow following the process shown in FIG. 7 in a case where a Web-screen notification is sent as a result of the counter value collection and inspection process shown in FIG. 7.

Referring to FIG. 9, when the user accesses the use restriction server RS from the client terminal Ct1 through CTn so as to log in at the httpd 21 of the use restriction server RS and enters a log-in request on the Web screen formed and provided by the Web page forming part 22, the Web page forming part 22 sends the request for authentication to the user management module 27 based on the log-in request.

When the user management module 27 performs the authentication based on a password or the like of the user who logs in, the result of OK of the log-in is returned to the Web page forming part 22.

The Web page forming part 22 queries the counter restriction module 25 about whether the counter values sum of the user who is permitted to log in exceeds the limit value. The counter restriction module 25 compares the limit value set for the user and registered in the counter information storage part 26 and the total of the counter values sum of the user so as to determine whether the counter value of the user exceeds the limit value.

When the counter values sum of the user exceeds the limit value, the counter restriction module 25 reports the exceeding occurrence situation to the Web page forming part 22. The Web page forming part 22 reports the situation that the counter values sum exceeds the limit and sends the pop-up display order to the client terminals CT1 through CTn via the httpd 21.

The Web browser 41 of the client terminal Ct1 through CTn displays the pop-up indicating that the counter values sum exceeds the limit, when the notification is sent from the httpd 21 of the use restriction server RS.

This pop-up display advises that the counter values sum exceeds the limit value in a message such as “The counter values sum has reached the use upper limit of the network device (MFP, printer, or the like). You will not be able to use the network devices.”

According to the above-discussed example, the user can learn in a proper way by using the Web function that the use of the network device ND1 through NDm is restricted, so that the use restriction can be properly performed and the convenience of use can be improved.

In the above-discussed explanation, when the counter values sum for a user exceeds the limit value, an e-mail is sent or the pop-up display is posted on the Web screen. However, reporting the counter values sum to the user is not limited to being made when the counter values sum exceeds the limit value. For example, when the counter values sum exceeds an advanced notification counter value (advanced notification number) being preset and lower than the limit value, notification by using e-mail, the Web screen, or the like may be made so that the user can learn that the counter value is close to the limit value.

For example, if the counter value exceeds a certain number such as the number that is 50, 100 or 150 lower than the limit value, the notification is made.

Using this method, the user can be notified that the counter values sum is close to the limit value before the counter values sum actually reaches the limit value. Hence, it is possible to further improve the convenience of use.

In addition, while the notification timing is set based on the counter values sum so that the notification is made in the above-discussed examples, the present invention is not limited to this. For example, the counter values sum of each user, namely the status of use of the network device ND1 through NDm may be reported by e-mail or the Web screen based on the preset notification schedule.

For example, the counter values sum of each user, namely the status of use is reported by e-mail or the Web screen on every 10^{th} day, 20^{th} day, 30^{th} day or every Friday.

Under this structure, each user can know the change of the status of use. Hence, it is possible to further improve the convenience of use.

The notification of the use status is not limited to the notification indicating that the counter values sum exceeds the limit value or the notification indicating the present use status (present count value). For example, use frequency of each user for a preset designated period may be reported.

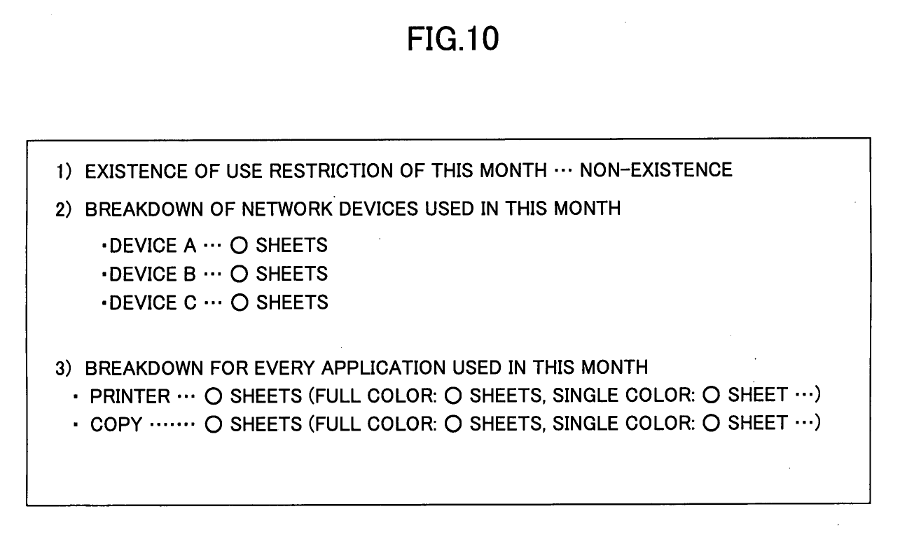

For example, the use status notification shown in FIG. 10 is sent every end of month by e-mail or the Web screen. Here, FIG. 10 is an example of notification contents of a using state notification process for a designated time by the printing system shown in FIG. 1.

In the use status notification shown in FIG. 10, the existence of use restriction of this month . . . non-existence, breakdown of network devices used in this month (device A . . . ◯ sheets, device B . . . sheets, device C . . . ◯ sheets), and breakdown for every application used this month (printer . . . ◯ sheets (full color: ◯ sheets, single color: ◯ sheet . . . ), copy . . . ◯ sheets (full color: ◯ sheets, single color: ◯ sheet . . . )) are reported by e-mail or Web screen.

Under this structure, each user can know the change of the status of use. Hence, it is possible to further improve the convenience of use.

In addition, the notification of the use restriction or the like may be sent to not only the corresponding user but also to other preset users simultaneously.

For example, if the counter values sum of a certain user exceeds the limit value so that the use restriction is in effect, notification is made to the user by e-mail or the Web screen and, simultaneously, notification by e-mail or the like of other preset users, such as a boss of the user, a manager of the network devices ND1 through NDm, or a supply manager of the network devices ND1 through NDm, is made.

Using this method, it is possible to further properly perform management of use restriction or management of use of the network devices ND1 through NDm.

In the above-discussed examples, the printing jobs from the client terminals CT1 through CTn are directly transferred to the network devices ND1 through NDm via the network NW. In addition, the network devices ND1 through NDm perform, based on the use possibility information for every user from the use restriction server RS, use restriction control of the network devices ND1 through NDm for every user. However, the method for use restriction is not limited to the above discussed method.

For example, the use restriction may be performed by the following method. That is, the printing job of each user is transferred to the network device ND1 through NDm via the use restriction server RS. The number of uses of each user is counted as the counter value and stored in the use restriction server RS. Based on the counter value and the limit value, the necessity of use restriction is determined. If the use restriction is put into effect, printing for the printing job is rejected. In the case of copying, a request for an allowance for copying specifying the user is sent from the network devices ND1 through NDm to the use restriction server RS. The use restriction server RS determines the necessity of use based on the counter value of the user and the limit value. If the use restriction is necessary, the use restriction server RS provides “non-allowance” to the request for a copying allowance.

According to the above-discussed embodiments of the present invention, it is possible to provide an image forming restriction control system, including:

an image forming apparatus; and

a use restriction device configured to restrict use of the image forming apparatus;

wherein the image forming apparatus and the use restriction device are connected to a network, and

the use restriction device includes
a user information storage part configured to store user information with respect to a user who is permitted to use the image forming apparatus;
an image forming number obtaining part configured to obtain a total sum of the number of pages where an image is formed for a designated time in each of plural of the image forming apparatuses for each of plural of the users who are permitted to use the image forming apparatuses;
a use information storage part configured to store the total sum of the number of the pages where the image is formed for every one of the users obtained by the image forming number obtaining part and a preset use restriction number;
a notification part configured to report information to the user;
a comparing part configured to compare the total sum of the number of pages where an image is formed and the preset use restriction number, at the designated timing; and
a control part configured to restrict the use of the image forming apparatuses by one of the users and initiate a notifying process for notifying the one of the users of the restriction of use to be performed by the notification part, in a case where the total sum of the number of the pages where the image is formed exceeds the preset use restriction number.

According to the above-discussed embodiments of the present invention, it is also possible to provide an image forming restriction control method wherein an image forming apparatus and a use restriction device configured to restrict use of the image forming apparatus are connected to a network, and restriction of image forming by the image forming apparatus is controlled by the use restriction device, the method including:

an image forming number obtaining process step of obtaining the total sum of the number of pages where an image is formed for a designated time in each of plural of the image forming apparatuses for each of plural of the users who are permitted to use the image forming apparatuses;

a comparing process step of comparing the total sum of the number of images formed and the preset use restriction number, at the designated timing; and

a control process step of restricting the use of the image forming apparatuses by one of the users and causing a notifying process for notifying the restriction of use to the restricted one of the users, in a case where the total sum of the number of pages where the image is formed exceeds the preset use restriction number.

According to the above-discussed embodiments of the present invention, it is also possible to provide a recording medium storing a computer program for controlling restriction of image forming in an image forming apparatus by a use restriction device where the image forming apparatus and the use restriction device configured to restrict use of the image forming apparatus are connected to a network, the computer program implementing a method, the method including:

an image forming number obtaining process step of obtaining the total sum of the number of pages where an image is formed for a designated time in each of plural of the image forming apparatuses for each of plural of the users who are permitted to use the image forming apparatuses;

a comparing process step of comparing the total sum of the number of images formed and the preset use restriction number, at the designated timing; and

a control process step of restricting the use of the image forming apparatuses by one of the users and causing a notifying process for notifying the restriction of use to the restricted one of the users, in a case where the total sum of the number of pages where the image is formed exceeds the preset use restriction number.

In the comparing process, the total sum of the number of pages where the image is formed of each of the users may be compared to an advanced notification number that is preset and lower than the use restriction number by a certain amount; and

notification that the number of pages where the image is formed exceeds the advanced notification number may be made to a corresponding one of the users if the total sum of the number of pages where the image is formed by the corresponding one of the users exceeds the advanced notification number in a control process.

In the control process step, at a designated timing, the present number of pages where the image is formed of each of the users obtained in the image forming number obtaining process step may be reported to the respective users.

In the image forming number obtaining process step, a use status of the image forming apparatus of each of the users may be collected for a designated period; and

in the control process step, the collected use status may be reported to the respective users.

In the control process, the notification may be made to the one of the users and a preset other user.

The notification may be made by sending an e-mail to the one of the users, the e-mail indicating the contents of the notification.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

This patent application is based on Japanese Priority Patent Application No. 2006-339324 filed on Dec. 18, 2006, the entire contents of which are hereby incorporated by reference.

What is claimed is:

1. An image forming restriction control system, comprising:
an image forming apparatus; and
a use restriction device configured to restrict use of the image forming apparatus;
wherein the image forming apparatus and the use restriction device are connected to a network, and
the use restriction device includes
a user information storage part configured to store user information with respect to a user who is permitted to use the image forming apparatus;
an image forming number obtaining part configured to obtain a total sum of the number of pages where an image is formed for a designated time in each of plural of the image forming apparatuses for each of plural of the users who are permitted to use the image forming apparatuses;
a use information storage part configured to store the total sum of the number of the pages where the image is formed for every one of the users obtained by the image forming number obtaining part and a preset use restriction number;
a notification part configured to report information to the user;
a comparing part configured to compare the total sum of the number of pages where an image is formed and the preset use restriction number, at the designated timing; and
a control part configured to restrict the use of the image forming apparatuses by one of the users and initiate a notifying process for notifying the one of the users of the restriction of use to be performed by the notification part, in a case where the total sum of the number of the pages where the image is formed exceeds the preset use restriction number.

2. An image forming restriction control method wherein an image forming apparatus and a use restriction device configured to restrict use of the image forming apparatus are connected to a network, and restriction of image forming by the image forming apparatus is controlled by the use restriction device, the method comprising:
an image forming number obtaining process step of obtaining the total sum of the number of pages where an image is formed for a designated time in each of plural of the image forming apparatuses for each of plural of the users who are permitted to use the image forming apparatuses;
a comparing process step of comparing the total sum of the number of images formed and the preset use restriction number, at the designated timing; and
a control process step of restricting the use of the image forming apparatuses by one of the users and causing a notifying process for notifying the restricted one of the users of the restriction of use to be performed by the notification part, in a case where the total sum of the number of pages where the image is formed exceeds the preset use restriction number.

3. A recording medium storing a computer program for controlling restriction of image forming in an image forming apparatus by a use restriction device where the image forming apparatus and the use restriction device configured to restrict use of the image forming apparatus are connected to a network, the computer program implementing a method, the method comprising:
an image forming number obtaining process step of obtaining the total sum of the number of pages where an image is formed for a designated time in each of plural of the image forming apparatuses for each of plural of the users who are permitted to use the image forming apparatuses;
a comparing process step of comparing the total sum of the number of images formed and the preset use restriction number, at the designated timing; and
a control process step of restricting the use of the image forming apparatuses by one of the users and causing a notifying process for notifying the restricted one of the users of the restriction of use to be performed by the notification part, in a case where the total sum of the number of pages where the image is formed exceeds the preset use restriction number.

4. The recording medium storing the computer program as claimed in claim 3,
wherein, in the comparing process, the total sum of the number of pages where the image is formed of each of the users is compared to an advanced notification number that is preset and lower than the use restriction number by a certain amount; and
notification that the number of pages where the image is formed exceeds the advanced notification number is made to the corresponding one of the users if the total sum of the number of pages where the image is formed by the corresponding one of the users exceeds the advanced notification number in the control process.

5. The recording medium storing the computer program as claimed in claim 3,
wherein, in the control process step, at a designated timing, the present number of pages where the image is formed of each of the users obtained in the image forming number obtaining process step is reported to the respective users.

6. The recording medium storing the computer program as claimed in claim 3,
wherein, in the image forming number obtaining process step, a use status of the image forming apparatus of each of the users is collected for a designated period; and
in the control process step, the collected use status is reported to the respective users.

7. The recording medium storing the computer program as claimed in claim 3,
wherein, in the control process, the notification is made to the restricted one of the users and a preset other user.

8. The recording medium storing the computer program as claimed in claim 3,
wherein, the notification is made by sending an e-mail to the restricted one of the users, the e-mail indicating the contents of the notification.
